(19) United States
(12) Patent Application Publication
(10) Pub. No.: US 2017/0232513 A1
(43) Pub. Date: Aug. 17, 2017

(54) SYSTEMS AND METHODS FOR BIAXIAL SYMMETRIC CANTED HOLES

(71) Applicant: The Boeing Company, Chicago, IL (US)

(72) Inventor: Mathew A. Coffman, Saint Charles, MO (US)

(21) Appl. No.: 15/042,378

(22) Filed: Feb. 12, 2016

(51) Int. Cl. B22F 3/105; B33Y 30/00; B22F 3/20; B22F 5/10; B23H 9/14; B24C 1/04; B23H 11/00; B23K 26/382; B23K 26/08; B23K 26/042; B29C 67/00; B33Y 10/00; B23H 1/00

(52) U.S. Cl. CPC B22F 3/1055; B33Y 10/00; B33Y 30/00; B22F 3/20; B22F 5/10; B23H 9/14; B23H 1/00; B23H 11/003; B23K 26/382; B23K 26/083; B23K 26/042; B29C 67/0066; B29C 67/0055; B29C 67/0088; B24C 1/045; B22F 2003/1057

(57) ABSTRACT

Systems and methods according to one or more embodiments are provided for forming canted holes in materials. In one example, a forming angle and a central axis for a vent through a panel is determined. A vent is formed in the panel about the central axis along the forming angle. The angled vent is formed with a circular shape at a first opening of the vent on a first surface of the panel when viewed at an angle perpendicular to the first surface of the panel. Additional systems and methods are also provided.

### TECHNICAL FIELD

One or more embodiments of the present invention relate generally to forming holes through materials, and more particularly, for example, to forming biaxial symmetric canted holes.

### BACKGROUND

In the field of forming holes through materials to vent fluid or gaseous media, there is an ongoing effort to provide improvements and cost savings to efficiently and effectively vent media. Conventional techniques of forming large arrays of holes for use as vents may significantly add aerodynamic resistance, be susceptible to surface cracks and/or have associated design issues.

### SUMMARY

Systems and methods are disclosed herein in accordance with one or more embodiments that provide an improved approach to forming holes in materials. In some embodiments, a canted hole is formed as a vent in a panel disposed parallel to a fluid flow to provide for air and/or fluid to flow through the vent. In one example, a forming angle and a central axis for a vent through a panel is determined. A vent is formed in the panel about a central axis along the forming angle. The angled vent is formed with a circular shape at a first opening of the vent on a first surface of the panel when viewed at an angle perpendicular to the first surface of the panel.

In one embodiment, a method includes determining a forming angle for a vent through a material, wherein the forming angle varies in a range of five degrees to eighty-five degrees from an angle perpendicular to a first surface of the material; determining a central axis of the vent along the forming angle; and forming the vent in the material about the central axis along the forming angle, wherein the vent is formed such that a first opening of the vent on the first surface of the material is circular in shape when viewed at an angle perpendicular to the first surface of the material.

In another embodiment, a system includes a cutting system; and a controller configured to: receive a forming angle for a vent through a material, wherein the forming angle varies in a range of five degrees to eighty-five degrees from an angle perpendicular to a first surface of the material; receive a central axis of the vent along the forming angle; and control the cutting system to form the vent in the material about the central axis along the forming angle, wherein the vent is formed such that a first opening of the vent on the first surface of the material is circular in shape when viewed at an angle perpendicular to the first surface of the material.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of a vent fabrication system in accordance with an embodiment of the disclosure.

FIG. 2A illustrates a view perpendicular to a surface of a vent panel formed with a plurality of vents in accordance with an embodiment of the disclosure.

FIG. 2B illustrates a rotated view of the vent panel of FIG. 2A in accordance with an embodiment of the disclosure.

FIG. 3 illustrates a cross-section view taken at line 3-3 of the vent panel of FIG. 2A in accordance with an embodiment of the disclosure.

FIG. 4A illustrates an isometric view of a vent through a vent panel in accordance with an embodiment of the disclosure.

FIG. 4B illustrates a cross-section view taken at line 4B-4B of the vent panel of FIG. 4A in accordance with an embodiment of the disclosure.

FIG. 4C illustrates a cross-section view taken at line 4C-4C of the vent panel of FIG. 4A in accordance with an embodiment of the disclosure.

FIG. 5 illustrates an exploded view of a laminate vent panel including a vent formed within the vent panel in accordance with an embodiment of the disclosure.

FIG. 6 illustrates a process for forming a vent in a vent panel in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

Techniques are provided to form canted holes in materials, such as for example to provide for efficient fluid flow through the material. Canted holes may be formed as vents in materials, for example, as panels on aircraft for directing airflow along an aircraft skin or directing water flow along the hull of a ship. The panel may include a plurality of vents formed in an array. The vents may be formed at an angle to facilitate the moving flow field at a first surface of the panel. The angled vent, when formed, includes a circular shape opening at a first surface on the panel when viewed at an angle perpendicular to the first surface. Incorporating circular shapes for vent openings at a surface of the panel may simplify design equations used for aerodynamic and electromagnetic analyses. In this regard, the vent design may be optimized for fluid flow, aerodynamic performance, and/or electromagnetic performance.

In various embodiments, a method for forming a vent in a panel includes implementing a cutting system to make a plurality of small cuts about a central axis of the vent along a forming angle (e.g., an angle determined to optimize flow of fluid through the panel) in the panel. Small cuts are made in the material in a pattern such that a first opening of the vent on a first surface of the panel is circular in shape when viewed at an angle perpendicular to the first surface.

In various embodiments, the processing techniques described herein may be advantageously used to reduce aerodynamic resistance as the vents are angled at an offset from perpendicular to the surface of the panel. Angled vents in panels provide for an extended length within the panel compared to perpendicular vents. Extended vent length provides for greater surface area contact with the moving fluid providing for increased thermal transfer or other environmental conditioning advantages where additional internal surface area is required. Furthermore, angled vents incorporating circular shapes on the surface of the vent panel may reduce the possibility of cracks at the perimeter of the vent opening. Incorporating circular shapes on the surface of the vent panel may simplify design equations used for aerodynamic and electromagnetic analyses thereby reducing costs for vent panel design.

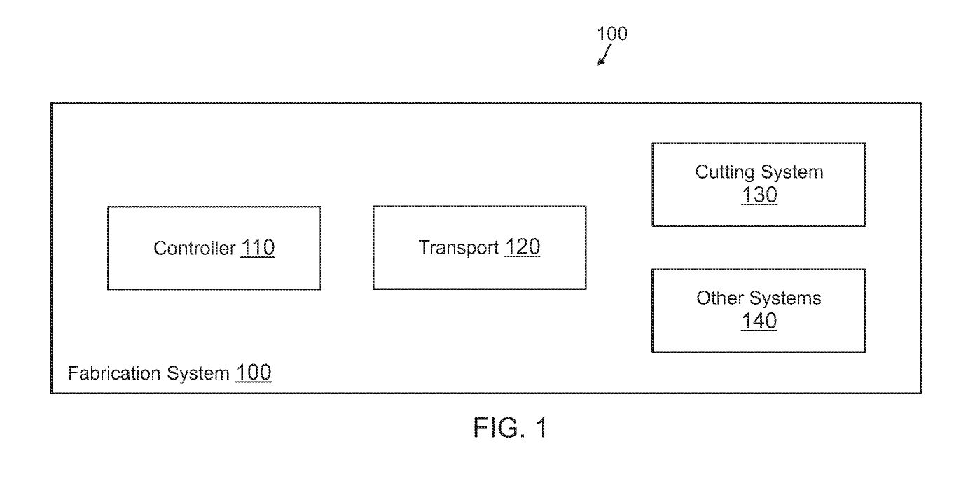

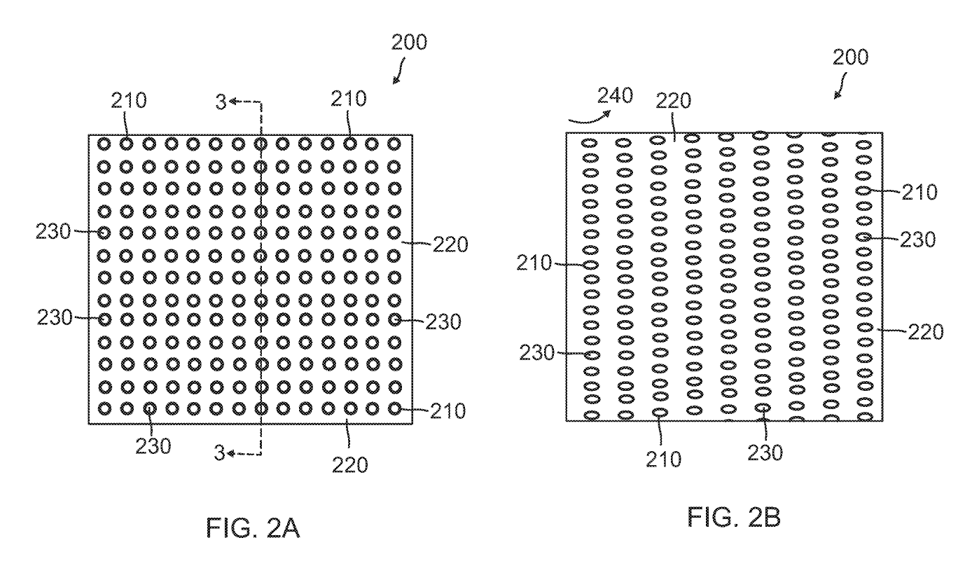

FIG. 1 illustrates a block diagram of a vent fabrication system 100 in accordance with an embodiment of the disclosure. As shown in FIG. 1, vent fabrication system 100 includes a controller 110, a transport 120, a cutting system 130, and other systems 140. Fabrication system 100 may be configured to use multiple different types of manufacturing or fabrication processes to form vents in a panel (e.g., such as vents 210 in panel 200 of FIG. 2A), as described herein. FIG. 2A illustrates a view perpendicular to a surface of a vent panel 200 formed with a plurality of vents 210. Vents 210 may include a biaxial symmetric canted hole (e.g., hole) formed in panel 200 by implementing one or more embodiments of cutting system 130. In various embodiments, controller 110 may be configured to control the various elements of vent fabrication system 100 to form vents in a panel.

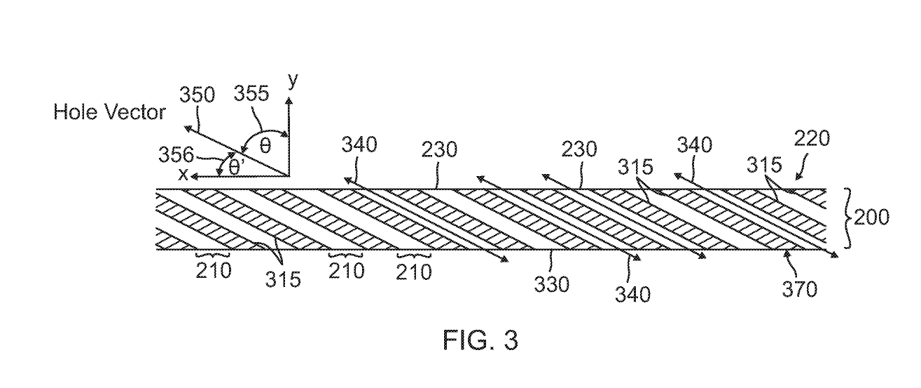

For example, in embodiments where vent fabrication system 100 is implemented as a cutting system 130 (e.g., a waterjet, a laser, and/or an electric discharge machining (EDM) system), controller 110 may be adapted to receive a forming angle (e.g., such as forming angle 350 of FIG. 3) for a vent 210 in a material (e.g., in the form of an electronic data file provided by an external logic device, such as a computer and/or a memory device) and to communicate to cutting system 130 to adjust a cutting head, for example, to the desired forming angle 350. In some embodiments, forming angle 350 may vary in a range of five degrees to eighty-five degrees from an angle perpendicular to a first surface of the material. Furthermore, controller 110 may be adapted to receive x-y coordinates of a central axis (e.g., central axis 340 of FIG. 3) of one or more vents formed in the material and to communicate to cutting system 130 to position the cutting head. FIG. 3 illustrates a cross-section view taken at line 3-3 of the vent panel 200 of FIG. 2A.

Controller 110 may be implemented with any appropriate logic device (e.g., processing device, microcontroller, processor, application specific integrated circuit (ASIC), field programmable gate array (FPGA), memory storage device, memory reader, or other device or combinations of devices) or distributed combination of logic devices that may be adapted to execute, store, receive, and/or provide appropriate instructions, such as software instructions implementing a method and/or control loop for creating a vent 210 in a panel 200, for example, implementing one or more elements of vent fabrication system 100. In addition, controller 110 may be implemented with one or more machine readable mediums configured to store non-transitory instructions and/or data files, such as design data files, for loading into and/or execution by controller 110. Such machine readable mediums may be internal, external, and/or otherwise configured to interface with controller 110. Controller 110 may be configured to receive non-transitory instructions and/or data files from sources remotely located from controller 110 and/or vent fabrication system 100. In these and other embodiments, the logic devices may be implemented with other components where appropriate, such as volatile memory, non-volatile memory, and/or one or more interfaces (e.g., inter-integrated circuit (I2C) interfaces, mobile industry processor interfaces (MIPI), joint test action group (JTAG) interfaces (e.g., IEEE 1149.1 standard test access port and boundary-scan architecture), various types of universal serial bus (USB) interfaces, Bluetooth™ interfaces, WiFi interfaces, and/or other wired and/or wireless interfaces).

In general, cutting system 130 may be configured to receive a material (e.g., a panel and/or structure made of a composite, a metal, a foam, and/or a laminate) and form vents in the material. In various embodiments, cutting system 130 may be implemented as a waterjet, a laser, and/or an EDM cutting system. In embodiments where cutting system 130 is at least partially implemented as a waterjet cutting system, a high pressure waterjet nozzle may be positioned to cut the material about the central axis along the forming angle 350 to form vent 210 in the material. In some embodiments, waterjet cutting system may receive instructions from controller 110 to make a plurality of small cuts (e.g., small cuts with a 0.020 inch or less kerf size) in the material in a pattern such that a first opening (e.g., such as first opening 230 of FIG. 2A) of vent 210 on a first surface (e.g., such as first surface 220 of FIG. 2A) of the material is circular in shape when viewed at an angle perpendicular to a first surface 220. In some embodiments, an abrasive material (e.g., such as garnet and/or aluminium oxide) may be added within the nozzle to cut, for example, metallic materials.

In embodiments where cutting system 130 is at least partially implemented as a laser cutting system, a focused laser beam is directed at the material to melt, burn, and/or vaporize the material. The focused laser may be positioned and/or adjusted at the material to cut the material about a central axis 340 along forming angle 350 to form vent 210 in the material. Similar to the waterjet cutting system discussed herein, the laser cutting system may receive instructions from controller 110 to make a plurality of small cuts (e.g., small cuts with kerf widths 0.010 inch or less) in the material in a pattern such that a first opening 230 of the vent on first surface 220 of the material is circular in shape when viewed at an angle perpendicular to first surface 220.

In embodiments where cutting system 130 is at least partially implemented as an EDM cutting system, (e.g., such as a wire EDM), an electrode is used to remove material. Similar to the waterjet cutting system, the electrode may be positioned and/or adjusted to cut the material about central axis 340 along forming angle 350 to form vent 210 in the material. Again, a plurality of small cuts are made in the material in a pattern dependent on forming angle 350 such that first opening 230 of vent 210 on first surface 220 of the material is circular in shape when viewed at an angle perpendicular to first surface 220.

In various embodiments, other systems 140 may include additive manufacturing (AM) systems such as a material extrusion AM system, a powder bed fusion AM system, and/or a vat photopolymerization AM system. Additive manufacturing systems may be implemented to form the panel and/or structure with the one or more vents 210 incorporated into the design. In this regard, controller 110 may receive a design for a vent panel (e.g., vent panel 200 of FIG. 2A) and provide instructions to the AM system to fabricate the panel with the one or more vents 210 incorporated. In embodiments where other systems 140 is at least partially implemented as a material extrusion AM system, a filament extrusion nozzle may be configured to dispense a material filament from a reel or spool and heat, soften, and/or melt the AM system material filament (e.g., using a heater) as it dispenses the AM system material filament in one or more patterned layers to form the vent panel 200 and/or vent structure on a build support.

In embodiments where other systems 140 is at least partially implemented as a powder bed fusion AM system, granules may be dispensed onto a build support in one or more patterned layers and melted and/or sintered into substantially connected patterned layers to form vent panel 200 and/or other structure incorporating vents. In embodiments where other systems 140 is at least partially implemented as a vat photopolymerization AM system, a bulk AM system material liquid may be dispensed in one or more patterned layers onto a build support to form vent panel 200. One or more lasers and/or other curing devices may be used to cure the patterned layers of the bulk AM system material liquid on build support to form vent panel 200. In all AM systems described herein, one or more vents 210 may be formed at forming angle 350 such that first opening 230 of vent 210 on first surface 220 of the material is circular in shape when viewed at an angle perpendicular to first surface 220.

In various embodiments, panels and/or other structures in various stages of manufacture may be conveyed between elements of vent fabrication system 100 by transport 120, which may be implemented as a device or vacuum chuck conveyance system, for example, and/or other transport configured to retrieve panels, structures, devices, and/or other structures from any element of vent fabrication system 100 and deliver them to another element of vent fabrication system 100. In some embodiments, transport 120 may be implemented, at least in part, by a user conveying a device or structure between elements of vent fabrication system 100. Operation of transport 120 and/or other elements of fabrication system 100, such as, cutting system 130 and/or other systems 140, may be controlled and/or otherwise facilitated by controller 110, which may be implemented as one or more monolithic or distributed logic devices, as described herein, that may be configured to communicate with any element of vent fabrication system 100 to operate vent fabrication system 100.

FIG. 2A illustrates a view perpendicular to a surface of a vent panel 200 formed with a plurality of vents 210 in accordance with an embodiment of the disclosure. Vent 210 provides for fluids to pass through panel 200 at a first surface 220. In one embodiment, a vent panel 200 may be mechanically coupled to an aircraft skin to provide for air and/or fluid to flow through vent 210 of panel 200. In other embodiments, vent panel 200 may be mechanically coupled to an exterior of a ship to provide for a fluid such as water to flow through vent 210 of panel 200. In various embodiments, vent panel 200 includes vents 210 formed at an angle to facilitate movement of the flow field at the first surface 220. Forming vent 210 at an angle in panel 200 (e.g., as compared to vents formed perpendicular in panel 200) provides for increased surface area contact of fluid flow along the surface of vent 210 providing increased thermal transfer of fluid to vent 210 channel (e.g., such as channel 315 of FIG. 3). In some embodiments, vent panel 200 may be formed from a composite, a metal, a foam, and/or a laminate, and other material suitable for venting a moving flow field. In various embodiments, vent panel 200 may be formed from a substantially planar and/or a contoured first surface 220 of vent panel 200.

Each vent 210 of vent panel 200 may be formed at a forming angle (e.g., such as forming angle 350 of FIG. 3) through vent panel 200. Vent 210 may be formed with a circular shape at a first opening 230 when viewed at an angle perpendicular to first surface 220 of vent panel 200. By forming circular shapes at first opening 230, design equations used in analyses, as discussed herein, are simplified resulting in design cost savings. Furthermore, circular shapes at first opening 230 reduce risk of crack initiation at vent 210 first opening 230.

FIG. 2B illustrates a rotated view of the vent panel 200 of FIG. 2A in accordance with an embodiment of the disclosure. As shown in FIG. 2B, vent panel 200 is rotated to an angle 240 equivalent to the forming angle of vent 210. Accordingly, view of FIG. 2B provides a longitudinal view of vent 210. In some embodiments channel 315 of vent 210 may be formed in an elliptical shape when cutting system 130 forms a circular shape at first surface 220. In other embodiments, channel 315 may be formed in various other shapes, for example, when cutting system 130 cuts channel 315 within area of first opening 230 (e.g., within area of circular shape). In this regard, forming a circular shape at first opening 230 provides for greater reliability and design cost savings.

FIG. 3 illustrates a cross-section view taken at line 3-3 of the vent panel 200 of FIG. 2A in accordance with an embodiment of the disclosure. FIG. 3 illustrates a cross-section view of vent panel 200 including a plurality of vents 210 formed in vent panel 200. Vent 210 may be formed by vent fabrication system 100 implementing, at least in part, cutting system 130. Vent 210 extends from a first surface 220 to a second surface 370 of vent panel 200. Vent 210 includes a first opening 230 formed on first surface 220, a channel 315 extending through vent panel 200, and a second opening 330 formed on a second surface 370. In some embodiments, vent panel 200 may be formed from a composite, a metal, a foam, and/or a laminate material. Vent panel 200 may be formed from a substantially planar first surface 220. As shown in FIG. 3, each vent 210 is formed about a corresponding one of a plurality of central axis 340. Central axis 340 of vent 210 may be aligned parallel to a flow field of a fluid and/or a gas moving at first surface 220 of vent panel 200 and through vent 210. Forming angle 350 (labeled Hole Vector) may be formed at an angle aligned parallel to central axis 340 and the flow field. In this regard, forming angle 350 may vary in a range of approximately five degrees to eighty-five degrees from an angle 355 (labeled θ) perpendicular (e.g., a sum of angle 355 and angle 356 (labeled θ′), or 90 degrees) to a first surface 220 of vent panel 200 material.

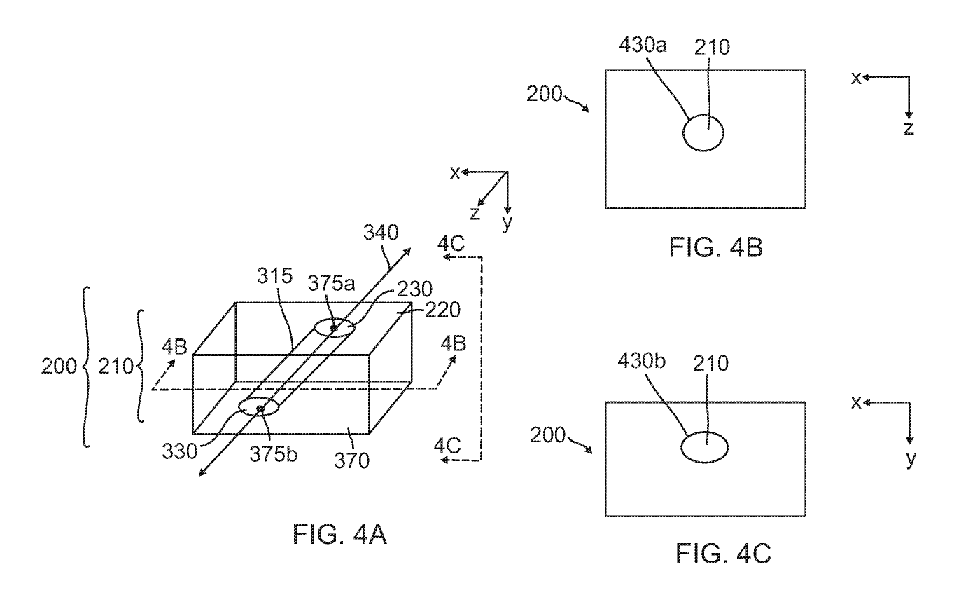

FIG. 4A illustrates an isometric view of a vent 210 through a vent panel 200 in accordance with an embodiment of the disclosure. FIG. 4A shows vent 210 formed through vent panel 200. Vent 210 includes first opening 230 formed on first surface 220 of vent panel 200. Channel 315 of vent 210 extends from first opening 230, through vent panel 200, to second opening 330. Second opening 330 may be formed on second surface 370. In some embodiments, first opening 230 and second opening 330 may be formed circular in shape with substantially the same diameter. In other embodiments, first opening 230 on first surface 220 may be formed with a first diameter and second opening 330 on second surface 370 may be formed with a second diameter. Central axis 340 extends at an angle along forming angle 350 (e.g., equal and/or substantially equal to forming angle 350) through a center point 375 (labeled 375a and 375b) of vent 210.

FIG. 4B illustrates a cross-section view taken at line 4B-4B of the vent panel 200 of FIG. 4A in accordance with an embodiment of the disclosure. As shown in FIG. 4B, vent 210 within vent panel 200 is a circular shape 430a at a cross-section parallel to a first surface 220. FIG. 4C illustrates a cross-section view taken at line 4C-4C of the vent panel 200 of FIG. 4A in accordance with an embodiment of the disclosure. As shown in FIG. 4C, vent 210 within vent panel 200 is an elliptical shape 430b at a cross-section normal to channel 315 of vent 210. In some embodiments, channel 315 may be formed after first opening 230 is formed on first surface 220 of vent 210. In this regard, cutting system 130 may be implemented to form channel 315 in a shape different than elliptical shape 430b. For example, cutting system 130 may be implemented to form channel 315 in a square shape, a circular shape, and/or various other shapes.

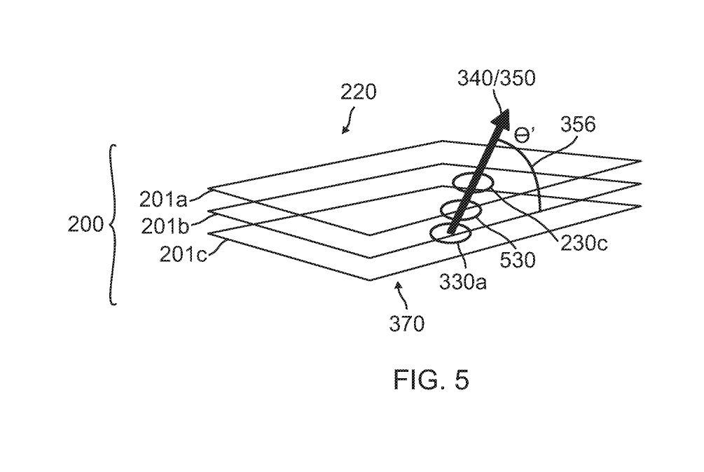

FIG. 5 illustrates an exploded view of a laminate vent panel 200 including a vent 210 formed within the vent panel 200 in accordance with an embodiment of the disclosure. As shown in FIG. 5, vent panel 200 includes one or more laminate layers 201 (labeled laminate layers 201a, 201b, and 201c). Vent 210 may be formed through laminate layers 201 at an angle 356 (labeled θ′) extending from a first surface 220 through laminate layers 201 to a second surface 370 of vent panel 200 along central axis 340. Vent 210 may form first opening 230a on laminate layer 201a, opening 530 on laminate layer 201b, and second opening 330a on laminate layer 201c. In this regard, a circular shape on each laminate layer 201 may reduce the possibility of cracks at the perimeter of the vent opening.

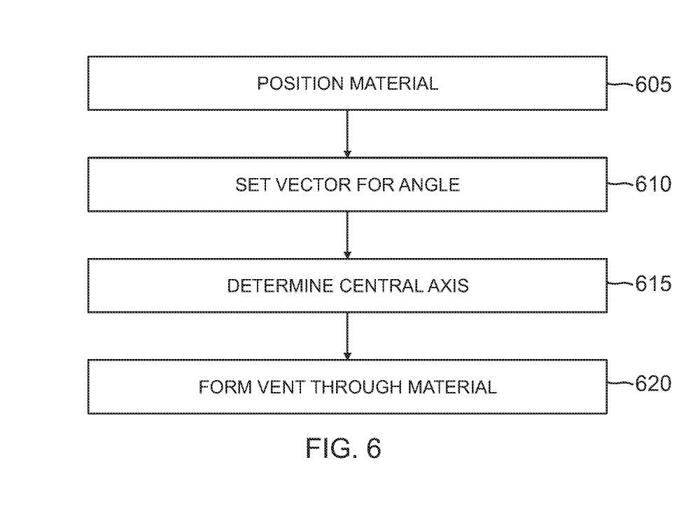

FIG. 6 illustrates a process for forming a vent 210 in a vent panel 200 in accordance with an embodiment of the disclosure.

In block 605, vent panel 200 may be positioned within fabrication system 100 at cutting system 130 in preparation for forming vents 210 in vent panel 200. In one embodiment, vent panel 200 may include a panel and/or structure made of a composite, a metal, a foam, and/or a laminate. A first surface 220 of vent panel may be substantially planar and/or contoured. In another embodiment, vent panel 200 material may include one or more AM system 140 materials such as a filament, a granule and/or a liquid AM system material. In various embodiments, cutting system 130 may be implemented as a waterjet, a laser, and/or an EDM cutting system. Transport 120 may be adapted to transport vent panel 200 material to cutting system 130 and/or move cutting system 130 to vent panel 200 material. Operation of transport 120 and/or cutting system 130 and/or other systems 140, may be controlled and/or otherwise facilitated by controller 110.

In block 610, a forming angle 350 may be determined for vent 210. Vent panel may include one or more vents 210. Vents 210 may be formed on vent panel 200 in an array. In some embodiments, a single forming angle 350 may be determined for a plurality of vents 210 within vent panel 200. In other embodiments, one or more forming angles may be determined for vent panel 200. Forming angle 350 may be determined to provide an optimal fluid flow through vent 210. In this regard, a forming angle 350 may be determined such that vent 210 is disposed at an angle in a direction of the moving flow field at a first surface 220 of vent panel 200. Controller 110 may be adapted to receive forming angle 350 (e.g., in the form of an electronic data file provided by an external logic device, such as a computer and/or a memory device) and provide forming angle 350 to cutting system 130.

In block 615, one or more central axis may be determined for vent 210. In some embodiments, vent panel 200 may include a single vent 210. In other embodiments, vent panel 200 may include an array of vents 210. For each embodiment, a central axis 340 may be determined for each vent 210. Central axis 340 extends at an angle along forming angle 350 through a center point 375 of vent 210. Controller 110 may be adapted to receive central axis in the form of an electronic data file provided by an external logic device, such as a computer and/or a memory device and provide central axis to cutting system 130.

In block 620, one or more vents 210 may be formed in vent panel 200. In this regard, cutting system 130, implemented as one or more waterjet, laser, and/or EDM cutting systems, may cut a plurality of small holes in vent panel 200 about forming angle 350 to form vent 210. Furthermore, vent 210 may be formed such that a first opening 230 of vent 210 on a first surface 220 of vent panel 200 is circular in shape when viewed at an angle perpendicular to the first surface 220. In some embodiments, first opening 230 and second opening 330 of vent 210 may be formed circular in shape with substantially the same diameter. In other embodiments, first opening 230 on first surface 220 of vent 210 may be formed with a first diameter and second opening 330 on second surface 370 of vent 210 may be formed with a second diameter.

In some embodiments, vent panel 200 and/or vents 210 may be formed by implementing other systems 140 implemented as an additive manufacturing (AM) system. AM system may include a material extrusion AM system, a powder bed fusion AM system, and/or a vat photopolymerization AM system. In other embodiments, vent 210 may be formed such as with a drilling and/or milling tool that may form an elongated shape at first opening 230 and/or second opening 330. Fabrication system 100 may implement cutting system 130 to form first opening 230 and/or second opening 330 in a circular shape after drilling and/or milling vent 210.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
determining a forming angle for a vent through a material, wherein the forming angle varies in a range of five degrees to eighty-five degrees from an angle perpendicular to a first surface of the material;
determining a central axis of the vent along the forming angle; and
forming the vent in the material about the central axis along the forming angle, wherein the vent is formed such that a first opening of the vent on the first surface of the material is circular in shape when viewed at an angle perpendicular to the first surface of the material.

2. The method of claim 1, wherein the vent is at least partially formed by a waterjet cutting system, wherein the waterjet cutting system is configured to cut the material about the central axis along the forming angle to form the vent in the material.

3. The method of claim 1, wherein the vent is at least partially formed by a laser cutting system, wherein the laser cutting system is configured to cut the material about the central axis along the forming angle to form the vent in the material.

4. The method of claim 1, wherein the vent is at least partially formed by an electric discharge machining (EDM) cutting system, wherein the EDM cutting system is configured to cut the material about the central axis along the forming angle to form the vent in the material.

5. The method of claim 1, wherein the vent is at least partially formed by an additive manufacturing system, wherein the additive manufacturing (AM) system comprises a material extrusion AM system, a powder bed fusion AM system, and/or a vat photopolymerization AM system.

6. The method of claim 1, wherein the material comprises:
a composite, a metal, a foam, and/or a laminate; and
wherein the first surface has a substantially planar and/or contoured surface.

7. The method of claim 1, wherein the forming the vent further comprises forming the circular shape with a first diameter at the first opening of the vent on the first surface of the material and forming the circular shape with a second diameter at a second opening of the vent on a second surface of the material.

8. The method of claim 1, further comprising forming a plurality of vents in the material, wherein each of the plurality of vents are formed about a corresponding one of a plurality of central axes along the forming angle.

9. The method of claim 1, further comprising forming a shape of a channel of the vent after forming the first opening of the vent on the first surface of the material, wherein the shape of the channel is a shape that is not elliptical.

10. A system comprising:
a cutting system; and
a controller configured to:
receive a forming angle for a vent through a material, wherein the forming angle varies in a range of five degrees to eighty-five degrees from an angle perpendicular to a first surface of the material;
receive a central axis of the vent along the forming angle; and
control the cutting system to form the vent in the material about the central axis along the forming angle, wherein the vent is formed such that a first opening of the vent on the first surface of the material is circular in shape when viewed at an angle perpendicular to the first surface of the material.

11. The system of claim 10, further comprising a transport system, wherein:
the transport system is adapted to move the material and/or the controller to the cutting system; and
the transport system is controlled by the controller.

12. The system of claim 10, wherein the material comprises:
a composite, a metal, a foam, and/or a laminate; and
a flat and/or contoured first surface.

13. The system of claim 10, further comprising the circular shape of the first opening of the vent on the first surface of the material is formed with a first diameter, and wherein a circular shape of a second opening of the vent on a second surface of the material is formed with a second diameter.

14. The system of claim 10, further comprising a plurality of vents formed in the material, wherein each of the plurality of vents are formed about a corresponding one of a plurality of central axes along the forming angle.

15. The system of claim 10, wherein the vent is at least partially formed by an additive manufacturing system, wherein the additive manufacturing (AM) system comprises a material extrusion AM system, a powder bed fusion AM system and/or a vat photopolymerization AM system.

16. The system of claim 10, wherein the vent is at least partially formed by a waterjet cutting system, wherein the waterjet cutting system is configured to cut the material about the central axis along the forming angle to form the vent in the material.

17. The system of claim 10, wherein the vent is at least partially formed by a laser cutting system, wherein the laser cutting system is configured to cut the material about the central axis along the forming angle to form the vent in the material.

18. The system of claim 10, wherein the vent is at least partially formed by an electric discharge machining (EDM) cutting system, wherein the EDM cutting system is configured to cut the material about the central axis along the forming angle to form the vent in the material.

19. A method of using the system of claim 10, the method comprising:
forming the vent in the material, wherein the forming angle for the vent is disposed at an angle in a direction of a media flow along the first surface of the material; and
channeling the media flow through the vent.

20. The system of claim 10, wherein the system is a panel comprising:
one or more vents formed in the panel; and
the one or more vents are formed in the panel about the central axis along the forming angle, wherein the vent is formed such that a first opening of the vent on the first surface of the material is circular in shape when viewed at an angle perpendicular to the first surface of the material.
